(19) United States
(12) Patent Application Publication
(10) Pub. No.: US 2005/0286122 A1
(43) Pub. Date: Dec. 29, 2005

(54) Microscope

(75) Inventors: Volker Seyfried, Nussloch (DE); Werner Knebel, Kronau (DE); Jan Schroeder, Mannheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems CMS Wetzlar GmbH, Wetzlar (DE)

(21) Appl. No.: 11/167,450

(22) Filed: Jun. 27, 2005

(30) Foreign Application Priority Data
Jun. 25, 2004 (DE) 10 2004 031 048.3

(51) Int. Cl. G02B 21/06

(52) U.S. Cl. 359/386

(57) ABSTRACT

A microscope includes at least one illuminating light source and an illumination beam path for guiding the illuminating light to a specimen. A detection beam path guides detected light from the specimen to a detector. An activatable element is positioned in the detection beam path for regulating and/or limiting the light power level in the detection beam path.

Priority is claimed to German patent application DE 10 2004 031 048.3, filed Jun. 25, 2004, the entire disclosure of which is hereby incorporated by reference herein.

The invention concerns a microscope, in particular a fluorescence microscope, having at least one light source, an illumination beam path guiding the light to a specimen, a detector, and a detection beam path guiding the detected light from the specimen to the detector.

### BACKGROUND

Microscopes of the kind under discussion here have been used for a long time in a wide variety of embodiments for numerous different applications. In some applications, in particular in some fluorescence experiments, the problem occurs that high-intensity radiation is generated in the specimen being examined, and high-intensity detected light is thus guided along the detection beam path to the detector. It may happen in this context that the quantity of radiation striking the detector is too great to be processed by the detector in the context of its technical capabilities. In addition to a considerable loss of image quality resulting from nonlinear behavior of the detector caused by the high light intensity, excessive radiation input can also cause damage to the detector or even, in some circumstances, result in complete destruction of the detector.

Fluorescence experiments performed in so-called “fly mode,” for example fluorescence recovery after photobleaching (FRAP) or fluorescence loss in photobleaching (FLIP), may be mentioned as examples of the effect just described. These are investigative methods in which a specimen is scanned bidirectionally by guiding an illuminating light beam at high speed over the specimen being investigated. Photomultipliers are generally used as the detectors for such experiments. Specifically, two serious problems may arise in this context: on the one hand, the charge quantities occurring in the photomultiplier may not be dissipated and processed quickly enough because of the high scanning speed in fly mode, resulting in unusable images. On the other hand, the high intensity of the fluorescent radiation striking the detector can cause damage to the detector, in particular damage to the sensitive photocathode of the photomultiplier.

One class of experiments in which the problems just described often occur are the FRAP experiments already mentioned above. In this type of experiment, a definable region of interest (ROI) is first irradiated with a low light intensity and then bleached with a high light intensity. The time course of the regeneration in fluorescent radiation is then measured. The recovery process can take place passively, e.g. by free diffusion, or by active transport processes. Fluorescein isothiocyanate (FITC) or GFP derivatives are often used as the fluorochrome for detecting molecular mobility, i.e. the movement of molecules from unbleached regions of the specimen into the bleached specimen region. Excessive stress on the detector can occur in this type of experiment as well, particularly during the bleaching operation.

### SUMMARY OF THE INVENTION

It is an object of the present invention to provide a microscope of the aforesaid kind with which interference-free image acquisition is possible and negative impact on the detector is avoided, even in the presence of critical investigative parameters such as a high scanning speed and/or strong excitation radiation during bleaching operations.

According to the present invention, there is provided in the detection beam path an activatable element for regulating and/or limiting the light power level in the detection beam path.

What has been recognized according to the present invention is firstly that in certain microscopic investigative methods, the quantity of detected radiation proceeding from the specimen and striking the detector represents a critical variable in terms of both the quality of the acquired image and damage to the detector. To prevent such damage, according to the present invention there is provided in the detection beam path an activatable element with which the detected radiation striking the detector can be regulated and/or limited. The arrangement according to the present invention eliminates, for example, the need to reduce the light intensity in the illumination beam path. An interference-free image can be acquired with reduced light intensity even when the fluorescence is very strong and scanning is very fast (including, for example, during a bleaching operation).

In a preferred embodiment, a rapidly switchable element is provided, “rapidly” in this context meaning that a time synchronization is possible between the scanning operation on the one hand and switching operations in the controllable element on the other hand. If the switchability is sufficiently rapid, the element can be switched during a scanning operation not only frame-by-frame or line-by-line, but on a pixel-by-pixel or even sub-pixel basis. Pixel- or sub-pixel-based switchability of the controllable element means that the quantity of radiation striking the detector can be regulated with extremely high accuracy, so that overmodulation of the detector can be effectively avoided during the entire scanning operation.

Line-by-line switchability of the element is advantageous especially in the context of experiments in which the specimen is bleached on the forward stroke of the scanner and observation occurs on the return stroke. Here the element can be switched during bleaching in such a way that, for example, the fluorescent radiation released is completely blocked out. But because specific information about the structure of the specimen may also be obtained during the bleaching operation, it is preferable merely to attenuate the fluorescent radiation instead of completely blocking it. During the forward stroke of the scanner, the element can be switched in such a way that the fluorescent radiation reaching the scanner is just sufficient for it still to operate in its dynamic range. In this fashion, at least the relative change in the intensity of the fluorescent radiation can be observed even during the bleaching process.

In advantageous fashion, provision could be made for the element to be programmable. It is conceivable, for example, for the switching states of the controllable element already to be definable, before a measurement, for the entire scanning operation. This is favorable when the radiation intensity that is predicted to be expected in the detection beam path within the ROI being examined is already at least approximately known prior to the measurement. Otherwise the element can be switched online during the measurement as a function of the quantity of radiation detected in each case.

In the interest of good flexibility, a controllable element that acts in wavelength-specific fashion can be arranged in the detection beam path. This allows, for example, illuminating light portions present in the detection beam path to be removed in controlled fashion from the detection beam path, so that the (fluorescent) detected light that is actually of interest does not have interfering excitation light, whose intensity often exceeds the intensity of the detected light by orders of magnitude, superimposed on it. Additionally or alternatively, the fluorescent light emitted from the specimen can be, for example, attenuated uniformly over the entire spectrum, or attenuated in spectrally sensitive fashion.

The controllable element could concretely be an acoustooptical modulator (AOM) or an acoustooptical deflector (AOD). It has been found that the aforesaid components are well suited for attenuating or completely removing fluorescent light from the detection beam path. The use of an acoustooptical filter (AOTF) is a good choice for blocking out, or suppressing as completely as possible, excitation light present in the detection beam path (which in practice is generally scattered excitation light produced in the system).

A liquid crystal display (LCD) or a liquid crystal tunable filter (LCTF) can also be used instead of an acoustooptical element to regulate the light power level of the fluorescent light present in the detection beam path.

The use of a grating light valve (GLV) is also conceivable. With these electrically controllable diffraction gratings, the incident detected light beam is either reflected or diffracted depending on the voltage applied to the grating (corresponding to a specific grating spacing). Because the ceramic strips constituting the grating must deflect only minimally in order to modify the reflection and/or diffraction characteristics of the grating, the use of these light valves is a good choice when rapid switchability is required.

For simple applications, particularly those in which wavelength-specific attenuation is not necessary, a galvanometer can be used as the controllable element.

In the interest of good flexibility for the arrangement, several, preferably two, controllable elements can be provided as an alternative to the use of a single controllable element in the detection beam path. For example, a first controllable element could be selected so that it specifically allows scattered excitation light to be blocked out, while the second controllable element could be designed for wavelength-specific suppression of fluorescent light.

To ensure that the light guided out of the detection beam path by means of the controllable element or elements does not scatter at system components and thereby possibly cause interference, one or more beam traps can advantageously be provided, in which the light guided out of the detection beam path is collected.

In terms of the positioning of the controllable element in the detection beam path, provision can be made for the activatable element to be arranged in front of a detection pinhole. If the microscope is operated with an achromat placed in front of the detection pinhole, it is a good choice to position the controllable element in front of the achromat.

Positioning of the controllable element behind the detection pinhole may also be useful in some cases.

### BRIEF DESCRIPTION OF THE DRAWING

There are various ways of advantageously embodying and refining the teaching of the present invention. The present invention is elaborated upon below based on an exemplary embodiment with reference to the drawing.

FIG. 1 shows is a schematic side view of an exemplifying embodiment of a microscope according to the present invention.

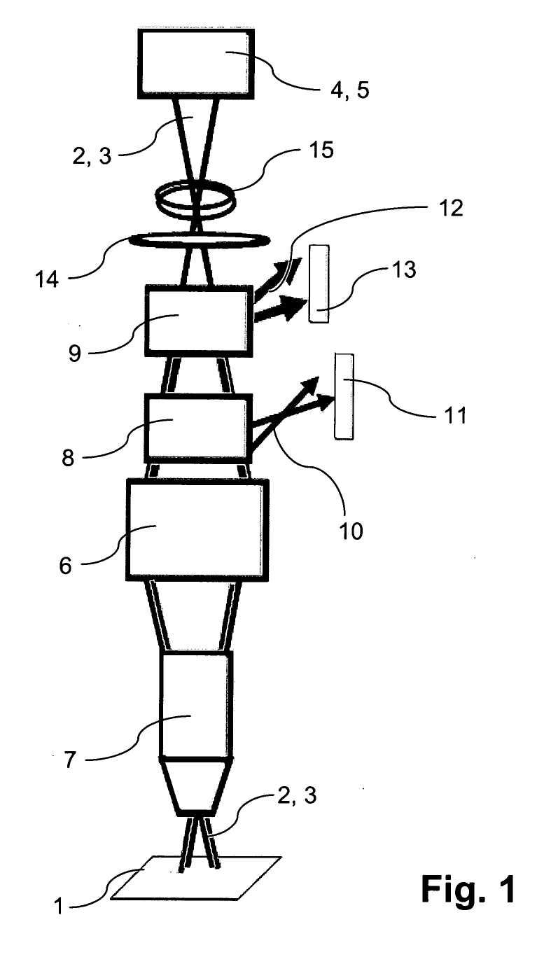

### DETAILED DESCRIPTION

The Figure schematically shows the general construction of an exemplifying embodiment of a microscope according to the present invention. Detected light 2 proceeding from specimen 1 is guided along a detection beam path 3 to a detector 5 embodied as a photomultiplier 4. The illuminating light is guided along an illumination beam path, via a beam splitter 6 and an objective 7, onto specimen 1. Detected light 2 travels through objective 7 and beam splitter 6 in the reverse order.

Two controllable elements for regulating and/or limiting the light power level in detection beam path 3 are arranged in front of photomultiplier 4 in detection beam path 3. In the exemplifying embodiment illustrated, these are an AOTF 8 and an AOM 9.

AOTF 8 is traversed by an acoustic wave that is generated by a piezoacoustic generator activated by a high-frequency source. By modifying the frequency of the waves traveling through AOTF 8, AOTF 8 can be switched in such a way that certain wavelength portions are removed from detection beam path 3 and do not strike photomultiplier 4. The desired wavelength portions are not influenced by the acoustic excitation, and are not blocked out of detection beam path 3. The undesired wavelength portions are interfering scattered excitation light 10, which is caught in light trap 11.

AOTF 8 is preferably driven so that detected light 2 passes through the crystal in the zero order, whereas the light to be removed is deflected into the positive first or negative first order. The crystal input and output surfaces are preferably cut so that no dispersion occurs for the zero-order beam (detected beam). The surfaces are therefore in an embodiment parallel.

AOM 9 is located behind AOTF 8 as a further controllable element. By modifying the RF power applied to AOM 9, the latter's diffraction efficiency can be modified. In the exemplifying embodiment depicted, AOM 9 is switched in such a way that undesired wavelength portions 12 of the fluorescent light emitted from specimen 1 are blocked out of detection beam path 3 and absorbed in beam trap 13.

AOM 9 is preferably driven so that the zero order of the diffracted light is used for detection, and the first order for light suppression.

Detected light 2 that remains in detection beam path 3 after AOTF 8 and AOM 9 passes through an achromat 14 and a detection pinhole 15, and finally strikes photomultiplier 4. This detected light 2 is limited (in wavelength-specific fashion) in terms of light power level in such a way that photomultiplier 4 is not overmodulated, and the incident light power level can be processed without difficulty, i.e. in particular with a linear response characteristic. Damage to or indeed destruction of photomultiplier 4 by excessive light input is thus effectively prevented.

It should be noted that other detectors, such as a CCD with image amplifier, an avalanche photodiode (APD), an electron-multiplying CCD (EMCCD), etc. can also be used instead of photomultiplier 4.

In conclusion, be it noted that the exemplifying embodiment discussed above serves merely to describe the teaching claimed, but does not limit it to the exemplifying embodiment.

1. A microscope comprising:
at least one light source configured to provide illuminating light;
an illumination beam path configured to guide the illuminating light to a specimen;
a detector;
a detection beam path configured to guide detected light from the specimen to the detector; and
an activatable element disposed in the detection beam path and configured to at least one of regulate and limit a light power level in the detection beam path.

2. The microscope as recited in claim 1 wherein the detected light includes fluorescent light.

3. The microscope as recited in claim 1 wherein the activatable element is rapidly switchable.

4. The microscope as recited in claim 1 wherein the activatable element is switchable on at least one of a frame-by-frame, a line-by-line, a pixel-by-pixel and a sub-pixel basis.

5. The microscope as recited in claim 1 wherein the activatable element is programmable.

6. The microscope as recited in claim 1 wherein the activatable element acts in wavelength-specific fashion.

7. The microscope as recited in claim 1 wherein the activatable element includes at least one of an acoustooptical modulator and an acoustooptical deflector.

8. The microscope as recited in claim 1 wherein the activatable element includes an acoustooptical filter.

9. The microscope as recited in claim 8 wherein the acoustooptical filter has parallel end faces.

10. The microscope as recited in claim 1 wherein the activatable element includes at least one of a liquid crystal display and a liquid crystal tunable filter.

11. The microscope as recited in claim 1 wherein the activatable element includes a grating light valve.

12. The microscope as recited in claim 1 wherein the activatable element includes a galvanometer.

13. The microscope as recited in claim 1 further comprising a second activatable element disposed in the detection beam path.

14. The microscope as recited in claim 1 further comprising a beam trap configured to collect light guided out of the detection beam path.

15. The microscope as recited in claim 1 further comprising a detection pinhole disposed downstream of the activatable element.

16. The microscope as recited in claim 15 further comprising an achromat disposed upstream of the detection pinhole and downstream of the activatable element.

17. The microscope as recited in claim 1 further comprising a detection pinhole disposed upstream of the activatable element.
